(19) United States
(12) Patent Application Publication
(10) Pub. No.: US 2023/0392395 A1
(43) Pub. Date: Dec. 7, 2023

(54) A SLIP FORM SYSTEM AND A METHOD OF CONTINUOUSLY FORMING A BUILDING STRUCTURE

(71) Applicant: Fastform Corporation Pty Ltd, Fremantle (AU)

(72) Inventors: Mike Schock, Fremantle (AU); Michael Kapfer, Fremantle (AU)

(21) Appl. No.: 18/037,059

(22) PCT Filed: Nov. 17, 2021
(86) PCT No.: PCT/AU2021/051363

§ 371 Date: May 15, 2023

(30) Foreign Application Priority Data
Nov. 17, 2020 (AU) 2020904233

(51) Int. Cl. E04G 11/24; E04G 21/04; E04G 21/12; G05D 3/12

(52) U.S. Cl. CPC E04G 11/24; E04G 21/04; E04G 21/12; G05D 3/12

(57) ABSTRACT

Embodiments of the present invention relate to a slip form system for forming a building structure comprising an inlet for receiving a flow of a material mixture comprising a setting material and an accelerant, a slip form, a support supporting the slip form and an actuator for continuously moving the slip form supported by the support. The slip form system further comprises a controller in communication with the actuator and configured to dynamically control the moving slip form, wherein the slip form system is configured such that when a flow of material mixture is received within the slip form, the controller uses information relating to a setting rate of the material mixture to control movement of the slip form to continuously form the building structure.

### TECHNICAL FIELD

The present invention relates to a slip forming system and a method of continuously forming a building structure. In particular, not exclusively though, the present invention relates to a vertical slip forming system and a method of continuously forming a vertical building structure, such as a wall.

### BACKGROUND

Slip forming is a construction method in which a setting material, such as concrete, is poured into a continuously moving form. In this way, continuous building structures, such as walls or other structures can be poured.

Conventionally, a steady rising rate for the movement of the slip form would be set and the slip form continuously moves according to the set rate. For vertical building structures, the slip form is typically supported by hydraulic jacks and workers may place steel reinforcing rods into the slip form while the building structure is formed.

A problem of the conventional slip forming arises when the setting material does not have a uniform setting rate and the rising rate does not conform to the setting rate of the material. As a consequence, deformations of the building structure may occur, such as bulging or cracks, or other structural problems. It would therefore be advantageous if at least an embodiment of the present invention overcame this problem or at least provided an alternative, workable solution to conventional slip form systems.

Any discussion of documents, acts, materials, devices, articles or the like which have been included in the present specification is not to be taken as an admission that any or all of these matters form part of the prior art base or were common general knowledge in the field relevant to the present invention as it existed before the priority date of each claim of this application.

Throughout the specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

In accordance with embodiments of the present invention, there is provided a slip form system for forming a building structure, the slip form system comprising:
an inlet for receiving a flow of a material mixture comprising a setting material and an accelerant;
a slip form having first and second longitudinally extending spaced side walls to define a space for receiving a flow of the material mixture from the inlet, the slip form defining cross-sectional dimensions of the formed building structure;
a support for supporting the slip form such that the slip form can continuously move along a building plane from a starting position to a finishing position, the building plane being defined by the building structure to be formed;
an actuator for continuously moving the slip form supported by the support; and
a controller in communication with the actuator and configured to dynamically control a speed of the moving slip form;
wherein the slip form system is configured such that when a flow of material mixture is received within the slip form, the controller uses information relating to a setting rate of the material mixture to dynamically control movement of the slip form to continuously form the building structure.

Embodiments of the slip form system provide significant advantages. In particular, the slip form system may enable the formation of a continuous, cast-in-place building structure. Even more so, by dynamically controlling the speed and/or angle of movement, the process of forming a building structure may be optimised. An embodiment of the present invention may significantly increase the lift rate and thereby the production rate of the building structure compared to conventional methods. Furthermore, with embodiments of the present invention there is no need for traditional formwork which generally accounts for a large proportion of the total costs for forming the building structure.

In an embodiment, the controller uses the information relating to a setting material of the material mixture to dynamically control the speed, position, acceleration and/or angle of movement of the slip form.

In an embodiment, the material mixture may further comprise a superplasticiser. A superplasticiser functions as a liquidiser to affect the flow rate of the material mixture, i.e. to make the material mixture flow more freely which may provide an improved surface finish of the formed building structure. A person skilled in the art will appreciate that other suitable admixtures may be added to the material mixture that affect the flow rate and/or the setting rate of the material mixture, for example, to increase early green strength of concrete.

In one embodiment, the slip form system may be configured to form a substantially vertical building structure. The vertical building structure may, for example, be a wall, such as a straight wall portion or a corner wall portion. In this example, the slip form system may be configured such that movement of the slip form is in a substantially vertical direction. However, a person skilled in the art will appreciate that other movements of the slip form are envisaged, for example, the slip form system may be configured to move the slip form in a substantially horizontal direction and/or along a substantially horizontal building plane. In this way, different building structures may be formed, such as a substantially horizontal building structure, a building structure at an angle or even a curved building structure.

In one example, the material mixture may be accelerated concrete. However, a person skilled in the art will appreciate that other material mixtures are envisaged. In some embodiments, the information relating to a setting rate of the material mixture is obtained by at least one sensor of the slip form system. In this regard, the information relating to the setting rate of the material mixture may be obtain continuously, periodically or upon request. By obtaining the setting rate while the building structure is being formed, any changes in the setting rate within the material mixture may be accounted for and movement of the slip form can be adjusted. Additionally or alternatively, the information in relation to the setting rate may be obtained from a database comprising empirical data based on a composition of the material mixture.

In a specific embodiment, the slip form system comprises a pressure sensor, for detecting a pressure of the material mixture against an inner portion of a side wall of the slip form. In this way, it is possible to determine information relating to the setting rate of the material mixture inside the slip form. Specifically, the controller of the slip form system may be in communication with the pressure sensor to use the detected pressure to dynamically control the movement of the slip form. For example, the controller may slow down the movement of the slip form when the detected pressure is above a pre-determined threshold.

In an embodiment, the slip form system comprises a sensor for determining yield stress of the material mixture within the slip form. For example, the sensor may be in the form of a penetrometer, such as an automated penetrometer, a microwave sensor or an ultrasonic sensor. In this way, it is possible to determine information relating to the setting rate of the material mixture inside the slip form. Specifically, the controller of the slip form system may be in communication with the yield stress sensor to use the detected yield stress to dynamically control the movement of the slip form.

In an embodiment, the slip form system may comprise a sensor for detecting resistivity between the first and second longitudinally extending side walls. In this regard, the slip form may comprise electrical contacts to apply a current through the material mixture within the slip form. The detected resistivity may increase as water content in the material mixture decreases and the material mixture sets. The controller of the slip form system may be in communication with the resistivity sensor to use the detected resistivity to dynamically control the movement of the slip form. For example, the controller may accelerate movement of the slip form when the detected resistivity is above a predetermined threshold.

In an embodiment, the slip form system may comprise a deflection sensor for detecting a deflection at a face of the formed building structure. The detected deflection at the face of the formed building structure may be indicative of the setting rate of the material mixture not having sufficient yield stress to be self-supporting. The slip form system may be configured to stop movement of the slip form if the deflection sensor is triggered. This is to allow yield stress to build prior to continuing movement of the slip form.

In an embodiment, the slip form system may comprise a flow sensor for detecting a flow rate of the material mixture, a component of the material or an admixture, such as an accelerant or plasticiser into the inlet and/or the slip form system, such as the mixing chamber of the slip form if present. In this example, the controller of the slip form system may be in communication with the flow sensor to use the detected flow rate to dynamically control the movement of the slip form. Additionally or alternatively, the detected flow rate may be used to control a dosage rate of any component and/or admixture of the material mixture, such as the accelerant relative to the flow rate of the material mixture.

In addition, the slip form system may be configured such that the flow rate of the material mixture may be controlled, for example, by the controller of the slip form system. This may be achieved by a variable control valve that is in communication with the controller. However, a person skilled in the art will appreciate that other ways to control the flow rate of the material mixture are envisaged. For example, the flow rate may be modified by controlling a pump providing the material mixture or at least a component of the material mixture.

In an example of the present invention, the slip form system comprises a pump for pumping the material mixture through the inlet into the slip form. In particular, a plurality of pumps may be provided, each being associated with one or more components of the material mixture. The one or more pumps may be in communication with the controller of the slip form system. The slip form system may be configured such that the material mixture is provided to the inlet continuously or periodically, such as in intervals or batches.

In an embodiment, the slip form system may comprise a first inlet for receiving a slurry comprising the setting material, and a second inlet for receiving the accelerant. In this case, the slip form system may comprise first and second pumps associated with the respective inlets. The slip form system may comprise a further inlet for receiving a plasticiser, such as a superplasticiser. The plasticiser has the function to make the material mixture less viscous. Further, the slip form system may comprise an inlet for receiving water, for example, to assist in cleaning components of the slip form system when forming the building structure has been completed.

In an embodiment, the slip form system, and in particular the mixing chamber if present may comprise a torque or current sensor for detecting a respective torque or current drawn by a mixing actuator that is mixing the slurry. The detected torque or current may be indicative of a viscosity or rheology of the material mixture. The controller may be in communication with the torque sensor or the current sensor to use the detected torque/current to control the dynamic movement of the slip form and/or the flow rate of one or more components of the material mixture. For example, the controller may use the detected torque of the mixing motor to increase or decrease a flow rate of the accelerant or plasticiser into the material mixture.

The slip form system may comprise a mixing tube or mixing chamber for mixing at least some components of the material mixture. The mixing tube or mixing chamber may comprise a rotating mixer or a static mixer for mixing the components of the material mixture. In this regard, the rotating mixer may be in the form of a mechanical stirrer. The torque sensor may be configured on the mixing actuator to detect a viscosity and/or rheology of the material mixture as it has been mixed within the mixing tube or mixing chamber.

In an embodiment, the controller of the slip form system may be configured to control a composition of the material mixture. For example, the controller may control a flow rate of the plasticiser and/or a flow rate of the accelerant and/or a flow rate of the setting material. By changing the composition of the material mixture, the setting rate of the material can be modified. For example, if more accelerant is added to the material mixture, the time for the material mixture to set may be shortened. Thus, the speed of movement of the slip form may be accelerated. In a specific example, any suitable sensor, such as the above described sensors may be utilised by the controller of the slip form system to control the composition of the material mixture.

In an embodiment, the slip form system may comprise a sensor for detecting a deformation of the formed building structure, such as a position or distance sensor. For example, when the slip form is moved too quickly and the material mixture has not set sufficiently, a deformation may be caused, in particular at opposite side portions of the formed building structure. The deformation may be in the form of a bulge in the formed building structure. The sensor for detecting the deformation may be in the form of a laser that is configured to emit a light beam perpendicular or parallel to the face of the continuously formed building structure. The controller of the slip form system may be in communication with the deformation sensor to use the detected deformation to dynamically control the movement of the slip form. Specifically, the slip form system may stop movement of the slip form if a deformation is detected to reduce the risk of failure of the formed building structure, which may have catastrophic consequences.

In an embodiment, the slip form system comprises at least one position sensor for determining a position of the slip form. In a specific example, the slip form system comprises a laser for detecting a position, such as a distance, for example of the slip form relative to the support and/or of the material mixture relative to the slip form. A person skilled in the art will appreciate that other position sensors are envisaged, including but not limited to ultrasonic, and infra-red.

Specifically, the at least one position sensor may be configured to measure a distance from the support, such as from a top portion of the support, to the slip form. For example, a distance may be measured from a top portion of the support to a top portion of one of the side walls of the slip form. The controller of the slip form system may be in communication with the at least one position sensor. In this way, the controller may determine a height of the formed building structure. Once a detected distance falls below a pre-determined threshold, the controller may be configured to stop the flow of the material mixture through the inlet and/or to stop movement of the slip form.

Additionally or alternatively, the at least one position sensor may be configured to determine a level of the material mixture within the slip form. For example, a first position sensor may measure a distance from the support to a top edge of the side walls of the slip form which may correspond to the height of the slip form, and a second position sensor may measure a distance from the support to the material mixture within the slip form. In this way, the controller may determine a level of material mixture within the slip form and may use the determined level to dynamically control the movement of the slip form or other variables of the system, such as the flow rate of the material mixture or composition of the material mixture.

In a further embodiment, the slip form system may comprise a sensor for detecting an orientation and/or angle of the slip form. One exemplary sensor may include an inertial measurement unit (IMU) to determine at least the angle of the slip form. The controller of the slip form system may be in communication with the sensor to dynamically control the angle of the slip form.

In an embodiment, the actuator is configured to be actuated electronically, hydraulically, mechanically or a combination of the aforementioned. Furthermore, the or a further actuator may be configured for controlling movement of the slip form, including but not limited to the speed, angle and acceleration of the slip form.

In an embodiment in which the slip form moves in a substantially vertical direction, the support supporting the slip form may comprise a lifting component for continuously lifting the slip form, for example, from the starting position to the or a finishing position. In addition, the lifting component may be configured to lower the slip form. The lifting component is connected to the actuator of the slip form system and may comprise mechanical components, electronic components, hydraulic components or a combination of the aforementioned.

In a specific embodiment, the slip form system may comprise a winch that is connected to the actuator and to the slip form via a rope or a cable. Thus, the slip form may be used by actuating and controlling the winch. This may be done automatically, or semi-automatically. For example, the controller may use detected signals from one or more sensors to automatically accelerate or slow down the movement of the slip form.

In an embodiment, the slip form system may be configured to move the slip form from a starting position where the flow of the material mixture is initiated, to a first finishing position where the flow of the material mixture is stopped, to a second finishing position where the slip form can be removed from the finished, formed building structure. For example, the second finishing position may be reached when a lower edge of the side walls of the slip form is higher than a top edge of the finished, formed building structure.

In an embodiment, the support for supporting the slip form may comprise a frame. The frame may comprise a plurality of posts for supporting the slip form, for example via a rope or cable as described above. In an embodiment, the frame of the slip form system may comprise a release component for moving the slip form off the building plane. For example, in cases in which the slip form moves along a vertical plane to form a vertical building structure, the frame may comprise a release component for moving the slip form off the vertical plane. In the example where the slip form is supported by the frame via a rope or cable, the release component may comprise one or more extensions at a top portion of the frame that guide the rope or cable away from the vertical plane. This may be implemented by the use of a pulley that moves along the extension of the posts.

In an embodiment, the slip form system comprises a material discharger for discharging the material mixture into the space defined within the slip form, wherein the material discharger is in fluid communication with the inlet. In one example, the material discharger comprises an outlet and is configured to evenly discharge the material mixture along the longitudinal space of the slip form. For example, the material discharger may comprise a plurality of outlets or a distribution channel along the length of the slip form.

In addition, the material discharger may comprise at least one variable control valve or nozzle such that flow through the valve or nozzle can be controlled. In embodiments in which the material discharger comprises a plurality of variable control valves, by selectively closing one or more of the valves, openings such as for windows, doors or other building services may be formed within the formed building structure.

In a further example, the material discharger comprises at least one material discharge unit or head that is moveable along a length of the slip form. The at least one material discharge unit or head may be in communication with the controller such that movement of the material discharge unit or head along the length of the slip form can be controlled.

In an embodiment, the slip form system may comprise a horizontal reinforcement dispenser for dispensing one or more reinforcement structures into the continuously forming building structure. The reinforcement dispenser may be configured to dispense one or more longitudinal, substantially horizontal reinforcement structures, such as steel bars, into the material mixture within the slip form. In a specific example, the reinforcement dispenser comprises a longitudinal cylinder for storing a plurality of reinforcement bars. The cylinder may comprise a longitudinal slit for dispensing an individual reinforcement bar such that when the cylinder is rotated about a central axis of the cylinder, a reinforcement bar is dispensed at periodic intervals. In an alternative example, the reinforcement dispenser may comprise a storage for storing a plurality of reinforcement bars with an opening. The reinforcement dispenser further comprises an actuator for lifting the stored reinforcement bars to move an individual reinforcement bar through the opening.

In an embodiment, the controller is part of or in communication with a computer system for processing data obtained from the slip form system, including but not limited to a setting rate, a time period for forming a building structure, detected pressures, temperature, resistivity, yield stress, material composition, IMU data, penetrometer resistance force, flow rate, movement of the slip form such as lift rate, height of the building structure, angle of lift, dimensions of the slip form and the like. The computer system may apply a learning algorithm or AI such that the controller may automatically control the movement of the slip form and/or composition of the material mixture, such as dosage rates of admixtures based on known material properties and system parameters.

In one particular example, the controller may comprise a network interface for communicating data to a remote computer system. The network interface may facilitate wireless communication with the remote computer system and/or one or more sensors of the slip form system.

The slip form system may comprise a power source connected to at least the controller. The power source may comprise one or more batteries.

In one particular embodiment, the slip form system is moveable. For example, the support of the slip form system may be configured to attach to an existing apparatus, such as a forklift, an excavator or a moveable scissor lift. This has the particular advantage that the slip form system can be moved once the first building structure is formed.

In examples in which the slip form system is moveable, the support may comprise a hydraulically actuated cylinder that is connected to a pump for actuating the cylinder. Alternatively, the support may be electrically actuated, such as by a motor.

In an embodiment, the slip form system comprises at least one sensor for detecting one or more of the following properties associated with the material mixture: a setting rate of the material mixture;
temperature of the mixing material;
a viscosity of the material mixture or of one or more components of the material mixture;
a level of material mixture within the slip form;
a height of the slip form;
a angle of the slip form; and
a height of the formed building structure;
wherein the one or more determined properties are used to dynamically control one or more of the following system parameters:
movement of the slip form;
the flow rate of the material mixture into the slip form; and
the flow rate of one or more components of the material admixture thereby modifying the composition of the material mixture.

In accordance with further embodiments of the present invention, there is provided a slip form system for forming a building structure, the slip form system comprising: an inlet for receiving a flow of a material mixture comprising a setting material and an accelerant;
a slip form having first and second longitudinally extending spaced side walls to define a space for receiving a flow of the material mixture from the inlet, the slip form defining cross-sectional dimensions of the formed building structure;
a support for supporting the slip form such that the slip form can continuously move along a building plane from a starting position to a finishing position, the building plane being defined by the building structure to be formed;
wherein the slip form system is configured such that the support is attachable to an existing apparatus with an actuator for continuously moving the slip form supported by the support; and wherein the slip form system is configured such that when a flow of material mixture is received within the slip form, information relating to a setting rate of the material mixture is used to dynamically control movement of the slip form to continuously form the building structure.

In an embodiment, the existing apparatus is moveable. Examples of existing apparatus may include but are not limited to an excavator, a forklift, a scissor lift and the like.

Embodiments of the present invention relate to a method of forming a building structure using slip forming, the method comprising:
providing a slip form supported by a support, the slip form being movable along a building plane from a starting position to a finishing position, the building plane being defined by the building structure to be formed;
pumping a flow of a material mixture into the slip form, the material mixture comprising a setting material and an accelerant;
obtaining information relating to a setting rate of the material mixture;
continuously moving the slip form along the building plane; and
dynamically controlling movement of the moving slip form using the information relating to the setting rate of the material mixture such that a continuous the building structure is formed.

In an embodiment, the step of obtaining the information relating to the setting rate of the material mixture may comprise detecting a pressure, a temperature, a yield stress and/or a resistivity of the material mixture in the slip form using a sensor, wherein the detected pressure/temperature/yield stress/resistivity, penetrometer resistance or microwave or UPV is indicative of the setting rate of the material mixture.

Additionally or alternatively, the step of obtaining the information relating to the setting rate of the material mixture may comprise communicating with a remote computer system to receive the information relating to the setting rate from an empirical dataset.

In an embodiment, the method may comprise determining one or more of the following properties associated with the material mixture:
a setting rate of the material mixture;
a temperature of the mixing material;
a viscosity of the material mixture or of one or more components of the material mixture;
a level of material mixture within the slip form;
a height of the slip form;
a angle of the slip form; and
a height of the formed building structure;
wherein the one or more determined properties are used to dynamically control one or more of the following system parameters:
the movement of the slip form;
the flow rate of the material mixture into the slip form; and
the flow rate of one or more components of the material mixture thereby modifying the composition of the material mixture.

It will be appreciated by persons skilled in the art that numerous variations and/or modifications may be made to the invention as shown in the specific embodiments and/or aspects without departing from the spirit or scope of the invention as broadly described. For example, it will be apparent that certain features of the invention can be combined to form further embodiments. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings.

### BRIEF DESCRIPTION OF DRAWINGS

Certain exemplary embodiments of the present invention will now be described, by example only, with reference to the accompanying drawings in which:

FIG. 1 shows an isometric view of a slip form system in accordance with an embodiment of the present invention;

FIG. 2 shows a further isometric view of the slip form system of FIG. 1 with a formed building structure, in this example a concrete wall structure;

FIG. 3 shows a detailed view of a material discharger of the slip form system of FIG. 1;

FIGS. 4 and 5 show detailed views of a reinforcement dispenser of the slip form system of FIG. 1;

FIG. 6 shows a detailed view of a reinforcement dispenser of a slip form system in accordance with a further embodiment of the present invention;

FIG. 7 shows a detailed view of a reinforcement dispenser of a slip form system in accordance with a further embodiment of the present invention;

FIG. 8 shows a schematic view of a movable slip form system attachable to a forklift in accordance with a further embodiment of the present invention;

FIGS. 9 to 11 show detailed views of a material discharger of the slip form system of FIG. 8; and

FIG. 12 shows a flow chart illustrating a method of forming a building structure using slip forming in accordance with an embodiment of the present invention.

### DESCRIPTION OF EMBODIMENTS

Embodiments of the present invention generally relate to a slip form system and a method for forming a building structure using a slip form. Slip forming is a construction method in which concrete or any other setting material is poured into a moving form. Slip forming may be used for forming vertical building structures, such as walls, building and dams, but also horizontal structures such as roads and road barriers. The slip form system in accordance with embodiments of the present invention generally comprises an inlet for receiving a flow of a material mixture, such as accelerated concrete. The material mixture comprises a setting material and an accelerant. The slip form system further comprises a slip form having first and second longitudinally extending spaced side walls to define a space for receiving a flow of the material mixture from the inlet. The configuration of the slip form typically defines some of the dimensions of the formed building structure, such as height, angle, width and/or depth. The slip form system further comprises a support for supporting the slip form such that the slip form can continuously move along a building plane from a starting position to a finishing position. The support may, for example, be in the form of a frame that is moved once the building structure is formed, or a support structure that is attachable to a moveable apparatus, such as a vehicle. The slip form may be moved in any suitable direction depending on the desired building structure. For example, the slip form may be moved in a substantially vertical direction, in a substantially horizontal direction or a combination of the aforementioned, depending on the requirements for the building structure that is formed.

The building plane is defined by the building structure to be formed. For example, the building plane may be a substantially vertical plane for a vertically extending building structure, such as a wall, and the slip form may move in a substantially vertical direction. If the building structure is a horizontally extending building structure such as a road or suspended concrete slab, the building plane may be a substantially horizontal plane and the slip form moves in a substantially horizontal direction. For a relatively low building structure, the building plan may be a substantially vertical building plane, while the slip form moves in a substantially horizontal direction. This may be applicable for a road barrier or the like.

The slip form system also comprises an actuator for continuously moving the slip form supported by the support, and a controller in communication with the actuator and configured to control movement of the slip form, such as speed, angle and/or acceleration. The actuator may be operated electrically, and/or hydraulically. The slip form system is configured such that when a flow of material mixture is received within the slip form, the controller dynamically controls the movement of the slip form to continuously form the building structure.

In some embodiments, the slip form system comprises one or more sensors for detecting a material property and the controller is configured to use the detected material property to dynamically control a system property, such as the speed and/or angle of movement of the slip form or the flow rate of the material mixture. Some possible sensors and detected properties will be described in detail below. However, a person skilled in the art will appreciate that any suitable sensors for detecting suitable material properties are envisaged. By obtaining information in relation to the setting rate of the material mixture by sensors, for example continuously or periodically, movement of the slip form can be dynamically adjusted to account for changes in the setting rate within the material mixture. As mentioned above, some problems of conventional slip forming arise due to a non-uniform setting rate of the concrete and slower production rates.

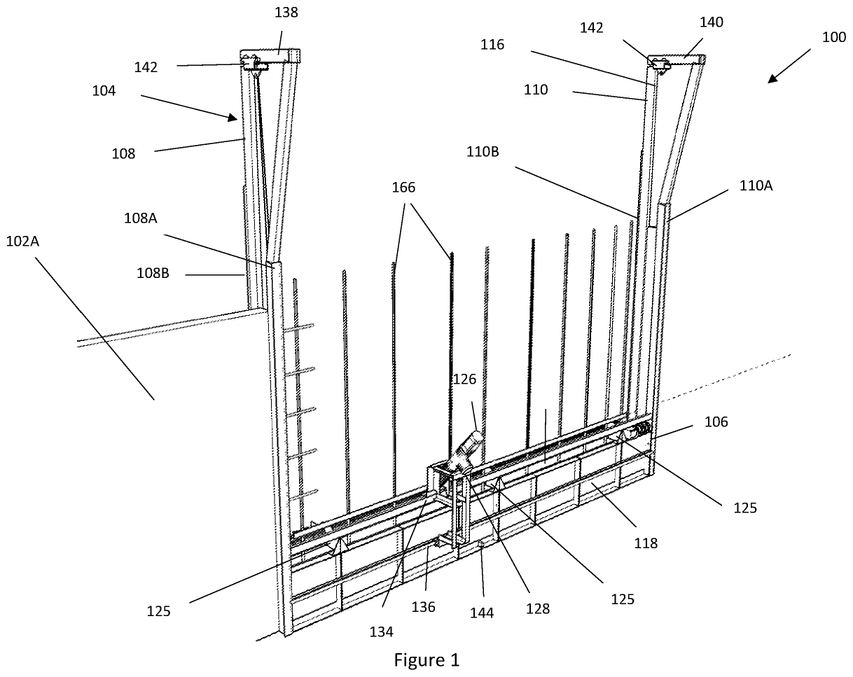

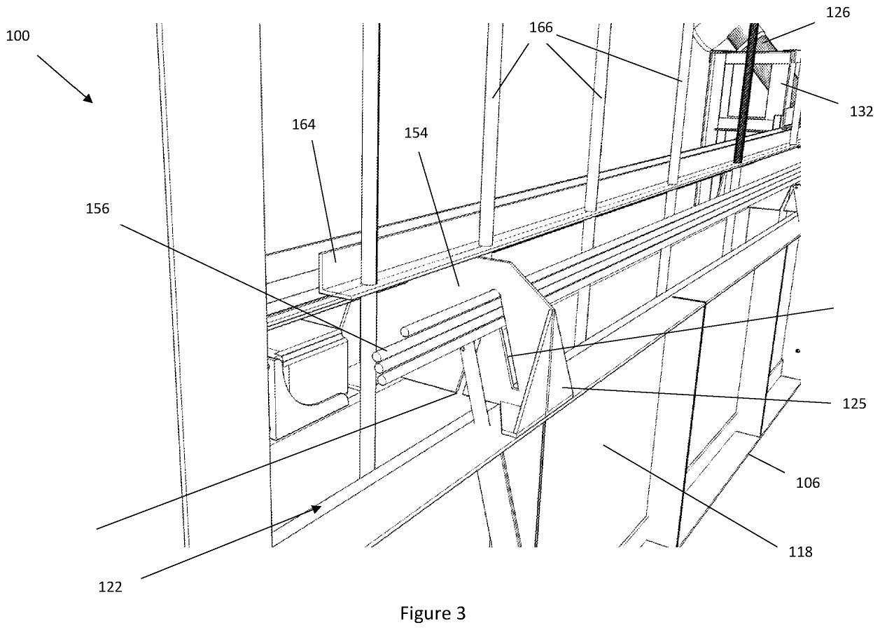

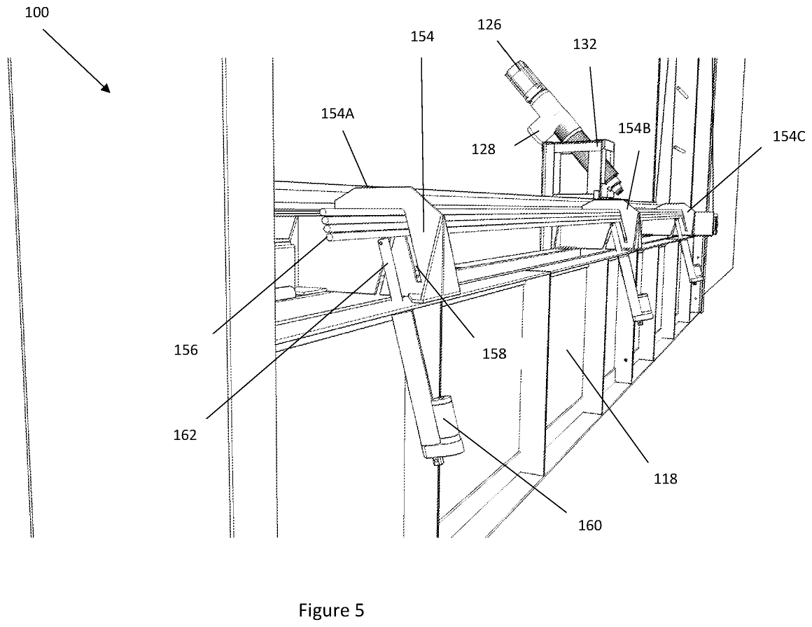

Referring initially to FIGS. 1 to 5 of the accompanying drawings, there is shown a schematic representation of a slip form system 100 in accordance with an embodiment of the present invention. In this particular embodiment, the slip form system 100 is configured to form a straight wall portion 102 made of concrete as shown in FIG. 3.

The slip form system 100 comprises a support for supporting the slip form 106, in this example a frame 104. The frame 104 comprises a plurality of posts 108, 110 that each comprises a winch 114 for supporting the slip form 106 via a cable 116 such that the slip form 106 can be raised and lowered. The slip form 106 comprises first and second longitudinally extending spaced side walls 118, 120 to define a space 122 for receiving a flow of a material mixture from an inlet 124.

The side walls 118, 120 of the slip form 106 are connected to each other through connectors 125. In this example, the connectors 125 are configured to rigidly connect the side walls 118, 120 to each other in a way to withstand the forces that are applied to the inner portions of the side walls 118, 120 when the wet material mixture is poured into the slip form 106. More specifically, the slip form 106 comprises three connectors 125 that are positioned at a top portion of the side walls 118, 120 of the slip form. This has the advantage that side portions of the side walls 118, 120 are free and can be positioned within guide rails or the like to continuously move along a defined building plane. A person skilled in the art will appreciate that connecting the side walls 118, 120 of the slip form 106 via rigid connectors on the top portion of the slip form 106 is only one specific implementation and other suitable methods are envisaged. For example, instead of providing rigid connectors, the connectors may comprise a hinge such that one of the side walls 118, 120 can be moved relative to the other side wall 118, 120. In this way, the slip form 106 may be opened to be removed from the building structure 102 once completed.

The material mixture, in this case accelerated concrete, comprises a setting material and an accelerant. The slip form system 100 may comprises an inlet 124 for receiving the material mixture. In this example, the slip form system 100 comprises multiple inlets for receiving respective components of the material mixture. Specifically, the slip form system 100 comprises a first inlet 126 for receiving the setting material, in this case a concrete slurry. The first inlet 126 may be directly connected to a pump of a concrete delivery vehicle (not shown). However, other arrangements are envisaged, such as a separate tank that may or may not be part of the slip form system 100. The slip form system 100 further comprises a second inlet 128 for receiving an accelerant. In this example, the second inlet 128 is in fluid communication with a tank (not shown) that comprises the accelerant. A person skilled in the art will appreciate that further inlets may be provided to receive any other suitable components of the material mixture, including but not limited to a plasticiser such as a superplasticiser, and water for cleaning purposes.

The slip form system 100 further comprises a material discharger 130 including an outlet with a valve or nozzle, that can be selectively opened and closed to discharge the material mixture into the space 122 defined by the slip form 106. In this example, the material discharger comprises a material discharge unit 132 that is movable along a length of the slip form 106. The material discharge unit 132 is in fluid communication with the first inlet 126 for receiving the setting material which in this case is a concrete slurry. The material discharger unit 132 further comprises the second inlet 128 for receiving the accelerant and in this particular case also a plasticiser. In this example, the second inlet 128 is controllable such that a dosage of the accelerant and plasticiser can be controlled by the controller of the slip form system 100. The material discharge unit 132 also comprises an outlet 133 for discharging the material mixture into the space 122 of the slip form 106. A person skilled in the art will appreciate that the outlet 133 may comprise a variable control valve or nozzle to control the flow rate of the material mixture discharged into the slip form 106.

The material discharge unit 132 is moveable along the length of the slip form 106 by moving on slide rails 134, 135 provided at top and side portions of the slip form 106. The material discharge unit 132 may be connected to the actuator of the slip form system 100 to control movement of the material discharge unit 132 on the slide rails 134, 135. For example, depending on the flow rate of the material mixture, a slower or faster movement of the material discharge unit 132 may be required. However, a person skilled in the art will appreciate that instead the material discharge unit 132 may comprise a separate actuator for controlling movement of the material discharge unit 132. By moving the material discharge unit 132 continuously back and forth along the length of the slip form 106, the slip form 106 can be filled with the accelerated concrete. Furthermore, by using a movable material discharger unit 132 with a variable control nozzle 133, it is possible to define openings within the formed building structure, for example to form windows, doors or other openings for building services.

In some examples (not shown), the second inlet for the accelerant is provided in close proximity to the outlet such that the accelerant can be injected into the concrete slurry shortly before the material mixture is discharged into the slip form 106. This has the particular advantage that the concrete slurry does not set within the material discharger.

In other embodiments (not shown), components of the material mixture flow into a mixing chamber where the components are mixed, for example, by a rotating mixer element such as a mechanical stirrer. This is where a sensor may be provided for detecting a torque of the mixing motor or a current draw. The detected torque or current may be indicative of a viscosity or rheology of the accelerated concrete which may be used by the controller to control the dosage of the accelerant and/or plasticiser. Once the components of the material mixture are sufficiently mixed, the accelerated concrete slurry is poured through the material discharger into the slip form.

The slip form 106 is supported by the frame 104 to be continuously moveable along a vertical plane from a starting position where a flow of the material mixture is initiated through the discharger 130 into the slip form 106 to a finishing position. This is achieved by each of the posts 108, 110 being configured to guide the slip form 106 along a defined path so that the slip form 106 moves along the building plane which is defined by the formed building structure 102. In this example, each post 108, 110 defines a pair of channels 108A, 108B, 110A, 110B within which the side walls 118, 120 of the slip form 106 move. Thus, the building plane is a substantially vertical plane defined by the vertical wall structure. Furthermore, each post 108, 110 defines a gap for accommodating the building structure 102 that is formed, in this example the wall portion 102. In other examples (not shown), each post 108, 110 may define a gap within which the slip form 106 moves. In such examples, opposite longitudinal end portions of the slip form 106 may comprise respective flanges to restrict movement of the slip form 106 in a direction parallel to the longitudinal axis of the slip form 106. This is particularly advantageous when the slip form 106 is supported by virtue of a winch 114. With regard to the frame 104, a person skilled in the art will appreciate that other configurations of continuously moving the slip form 106 are envisaged.

As described above, the slip form 106 is supported by the frame posts 108, 110 through a cable 116 that is connected to an actuator via a winch 114. In this way, the slip form 106 can be lifted and lowered by controlling the actuator. In this example, the actuator is part of a programmable logic controller (PLC) (not shown). The PLC is configured to control the speed of movement of the slip form 106 such that a continuous, cast-in-place wall structure 102 is formed.

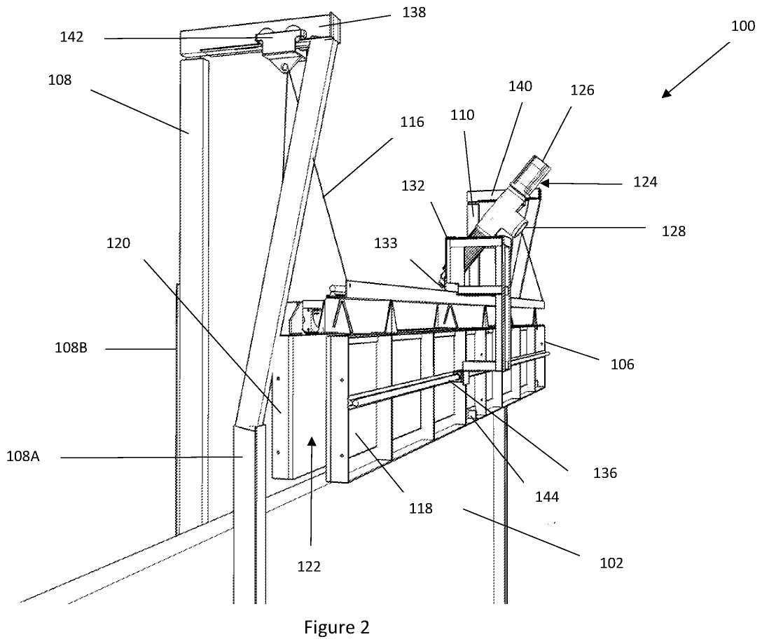

A person skilled in the art will appreciate that the configuration with a winch and an electric actuator is only one exemplary implementation of the invention. Other ways of moving the slip form are envisaged, such as the use of suitable mechanical components, electronic components, hydraulic components or a combination of the aforementioned. In this particular example, utilising a winch 114 has a particular advantage in that the slip form 106 can be removed from the finished wall portion in a relatively simple manner. Specifically, the slip form 106 continuously moves from a starting position where the flow of the material mixture is initiated, to a first finishing position where the flow of the material mixture is stopped, to a second finishing position where the slip form 106 is removed from the finished, formed building structure. For example, the second finishing position may be reached when lower edges of the side walls 118, 120 of the slip form 106 are higher than a top edge of the finished, formed wall structure 102, as shown in FIG. 2 of the accompanying drawings.

In order to remove the slip form 106 from the finished wall structure 102, the slip form 106 needs to be moved out of the building plane, in this case a vertical building plane. In order to achieve this, the frame 104 comprises a release component in the form of extensions 138, 140 provided at a top portion of respective posts 108, 110. The cable 116 supporting the slip form 106 moves along these extensions 138, 140 by virtue of a pulley 142 thereby pulling the slip form 106 in a direction away from the vertical plane. In this regard, the pair of channels 108A, 108B, 110A, 110B of the posts 108, 110 terminate at a position such that when the slip form 106 has reached the second finishing position, the slip form 106 can be moved out of the vertical plan and away from the formed building structure 102. As shown in FIG. 3, the channels may terminate approximately at the desired height of the formed building structure 102. In other examples in which the slip form 106 is positioned and held within the gap of outer posts 108, 110, a person skilled in the art will appreciate that the outer posts 108, 110 may need to be moved away from each other to release the slip form 106. Once the slip form 106 is moved out of the vertical building plane of the formed building structure 102, the slip form 106 may be lowered in a plane that is substantially parallel to the formed wall structure 102.

Referring back to FIG. 1 of the accompanying drawings, the slip form system 100 further comprises a plurality of sensors for detecting properties associated with the material mixture, in this case accelerated concrete. The PLC of the slip form system 100 uses the detected properties to dynamically control a speed of movement of the slip form 106 or other system parameters, some of which will be described below.

In this example, the slip form system 100 comprises a pressure sensor 144 for detecting a pressure of the accelerated concrete against an inner portion of one of the side walls 118, 120 of the slip form 106. In this way, it is possible to determine information indicative of a setting rate at which the accelerated material is hardening. Specifically, the more the concrete is set, the lower is the detected pressure. The pressure sensor 144 is in communication with the PLC, for example, by the use of a suitable wireless communication technology. The PLC uses the detected pressure obtained by the pressure sensor 144 to control at least the speed of movement of the slip form 106. For example, the PLC may slow down lifting the slip form 106 if the detected pressure is above a pre-determined threshold. This would indicate that the material mixture has not set sufficiently for the slip form 106 to continue to move. By obtaining information indicative of the real time setting rate of the accelerated concrete, the slip form system 100 can dynamically control the speed of movement of the slip form 106. In this way, the process of forming of the building structure can be optimised. Specifically, the speed of forming the building structure can be maximised without compromising on any deformation of the wall structure that would occur if the slip form 106 was moved too quickly or too slowly.

In this example, the slip form system 100 additionally comprises a deflection sensor to detect a deflection at a face of the formed building structure 102. This is also indicative of the setting rate of the material mixture in that a detected deflection is indicative that the material mixture has not developed sufficient yield stress. The PLC may instantly stop movement of the slip form 106 once a deflection has been detected by the deflection sensor.

A further suitable sensor that also indicates whether the material mixture has developed sufficient yield stress relates to a penetrometer. The penetrometer may be positioned on an inner wall portion of the side walls 118, 120 of the slip form 106. Specifically, one or more automated penetrometers may be used that comprise a pin that is automatically inserted into the material mixture within the slip form at regular intervals to determine a penetration force. For example, automated penetrometers may be positioned such that yield stress can be detected at different heights and positions relative to the slip form. For example, two penetrometers may be positioned at a bottom portion of the slip form on the left and right end portions, respectively, and two further penetrometers may be positioned at a centre portion on the left and right end portions, respectively. In this way, yield stress can be compared for different portions of the material mixtures. Penetrometers are well known in the art and will not be described here in further detail.

A further suitable sensor (not shown) may be a sensor for determining a resistivity of the material mixture within the slip form 106. In this regard, electrical contacts may be provided at the first and second side walls 118, 120 such that a current may be applied through the material mixture and a resistance or impedance can be measured. The measured resistance or impedance typically increases as water content of the material mixture decreases which is an indication that the material mixture sets. Thus, by determining the resistivity of the material mixture, real-time information indicative of the setting rate of the material mixture can be determined. Thus, the PLC 136 may use the information to control the movement of the slip form 106 or other parameters of the slip form system 100, such as the composition of the material mixture.

A further suitable sensor (not shown) may be a sensor for determining an integrity of the material mixture within the slip form 106. Suitable examples of this type of sensor may include but are not limited to an ultrasonic pulse velocity (UPV) sensor or a microwave moisture sensor. In these examples, the speed and attenuation of an ultrasonic wave or microwave are measured passing through the material mixture. The detected speed and attenuation may be used to determine information in relation to the setting rate of the material mixture.

Another suitable sensor may be a temperature sensor (not shown) for detecting a temperature of the material mixture, such as accelerated concrete, within the slip form 106. The detected temperature may be an indication of the strength of the catalytic reaction of the setting material, such as concrete and the accelerant admixture. It may also be an indication whether the accelerant has been dosage correctly and thoroughly mixed. The detected temperature may be used alone as an indication of the setting rate of the material mixture, or in combination with the pressure sensor 144 and/or the deflection sensor and/or other suitable sensors. Furthermore, the detected temperature may be an additional data point collected by the PLC that may be used by the system to dynamically control other system parameters. The slip form system may additionally or alternatively comprise a temperature sensor for detecting an ambient temperature which may also affect the movement of the slip form.

Another suitable sensor (not shown) may be a torque sensor for determining a viscosity of the concrete slurry provided through the first inlet 126. For example, a torque sensor may be provided on a mechanical stirrer or the like. The torque sensor typically is in communication with the PLC so that the PLC can use the detected viscosity or rheology to control parameters of the slip form system 100. For example, the PLC may use the detected torque to dynamically control the composition of the material mixture and thereby the viscosity. For example, if the material mixture is too viscous then dosage of plasticizer may be increased to liquefy the setting material, such as concrete. If the material mixture is not viscous enough, then dosage rate of the accelerant may be increased. This may be done by combining the detected torque with empirical data. In this regard, the PLC may comprise a network interface for communicating with a remote computer system (not shown). The network interface may facilitate wireless communication not only with the remote computer system but also with one or more of the sensors of the slip form system 100. Wireless communication technologies are well known in the art and will not be described in further detail in the present application. A person skilled in the art will appreciate that any suitable wireless communication technology is envisaged. In addition or as an alternative to the torque sensor, the slip form system 100 may comprise a current sensor (not shown) to measure the current draw by a mixing motor that mixes the concrete slurry with other additives, such as the accelerant.

In general, the PLC may use any suitable detected information in relation to the material mixture or components of the material mixture to control a composition of the material mixture. For example, the slip form system 100 may be configured to control the ratio of the accelerant within the material mixture or to control the ratio of a plasticiser or the like. By changing the composition of the material mixture, characteristics of the material mixture may be changed, including but not limited to the setting rate of the material and the rheology of the material mixture. For example, if more accelerant is added to the material mixture, the time for the material mixture to set may be shortened. Thus, the speed of movement of the slip form may be increased. Additionally or alternatively, the slip form system 100 may be configured to control the flow rate of the material mixture through the discharger 130 and/or the inlets 126, 128. In this regard, the slip form system 100 may also comprise a flow sensor for detecting a flow rate of the material mixture and/or components of the material mixture. For example, a flow sensor may be provided at the discharger 130, the first inlet 126 and/or the second inlet 128.

Referring back to FIG. 1, the slip form system 100 further comprises a sensor (not shown) for detecting a position, such as in this example a distance. More specifically, the slip form system 100 in this example comprises a plurality of distance sensors, each being in the form of a laser and positioned at a top portion of the posts 108, 110 of the frame 104. The distance sensor has the function of detecting a distance from the top portion of the frame 104 to a top edge of the side walls 118, 120 of the slip form 104. In this way, the position of the slip form 106 relative to the frame 104 can be determined. Whilst in this example the distance sensor is in the form of a laser, a person skilled in the art will appreciate that other distances sensors are envisaged.

The sensor may further be configured to detect a deformation of the formed building structure 102, specifically at a side face of the formed building structure 102. For example, when the slip form 106 is moved too quickly and the accelerated concrete has not set sufficiently, a deformation at the formed building structure 102 may be caused. A typical deformation is in the form of bulging at opposite side portions of the formed building structure 102. The PLC of the slip form system 100 may stop or slow down the movement of the slip form 106 as soon as a deformation is detected. In this way, the deformation may be corrected, for example by lowering the slip form 106 or by manually removing the deformation. Whilst in the example the sensor is configured to provide dual functions, a person skilled in the art will appreciate that the slip form system 100 may comprise a further sensor for detecting a deformation.

In this embodiment, the slip form system 100 comprises a second distance sensor (not shown) positioned at a top portion of the slip form 106. The second distance sensor is used to determine a level of accelerated concrete within the slip form 106. The PLC is in communication with the distance sensor and may use the detected distance to dynamically control the speed of movement of the slip form 106 or other parameters of the slip form system 100, such as the flow rate of the material mixture. For example, if the level of material mixture within the slip form 106 is above a predetermined threshold, the PLC may slow down or even stop the flow rate of material mixture. Furthermore, whilst the second distance sensor is positioned at a top portion of the slip form 106, it may alternatively be provided at a top portion of the frame 104 or be combined with the first distance sensor. For example, the first distance sensor may detected a first distance from the top portion of the frame 104 to the top edge of the slip form 106 and a second distance from the top portion of the frame 104 to the material mixture within the slip form 106. A difference between the measured distances is indicative of the level of material mixture within the slip form 106. Furthermore, the measured distances may be used to determine a flow rate of the material mixture.

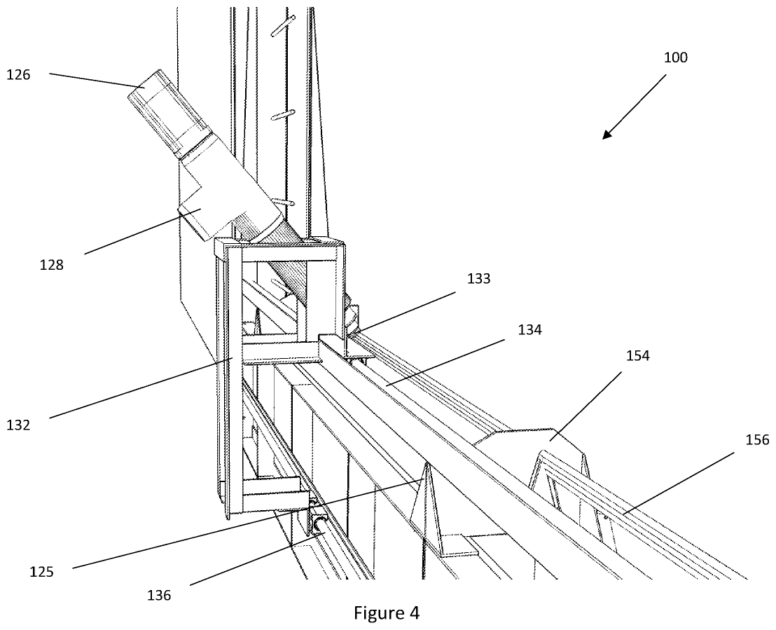

Referring now to FIGS. 3 and 4, the slip form system 100 comprises a reinforcement dispenser 154 for dispensing a plurality of substantial horizontal reinforcement bars 156 into the continuously forming building structure, in this case the wall structure 102. In this example, the reinforcement dispenser 154 comprises a plurality of dispenser units 154A, 154B, 154C that are arranged along a length of the slip form 106, wherein each dispenser unit comprises a substantially V-shaped slit 158 for storing the plurality of reinforcement bars 156. The reinforcement dispenser 154 further comprises an actuator, such as a stepping motor 160, for dispensing individual reinforcement bars 156 at periodic intervals. Specifically, a plurality of reinforcement bars 156 are stored within one leg of the V-shaped slit 158, wherein the stepping motor 160 is connected to a rod 162 that extends in length at periodic intervals to move individual reinforcement bars from one leg of the V-shaped slit 158 into the other leg of the V-shaped slit thereby causing the reinforcement bar 156 to fall into the space 122 of the slip form 106 and thus into the material mixture. In this way, substantially horizontal reinforcement bars 156 can automatically be cast in place within the formed building structure 102.

In addition to the reinforcement dispenser 154 for providing substantially horizontal reinforcement bars 156, the slip form system 100 further comprises a support 164 for supporting one or more substantially vertical reinforcement structures 166 as particularly shown in FIG. 3. For example, the support 166 may be configured to position a plurality of reinforcement bars 164, in a substantially vertical direction. Thus, a grid-like reinforcement structure may be cast in place within the continuously formed building structure.

As briefly described above, the PLC in this example comprises a wireless network interface for facilitating communication with a remote computer system (not shown). In this regard, the PLC may request information from the remote computer system. In addition, the PLC may send information collected by the one or more sensors of the slip form system 100 to the remote computer system. The information may be processed and stored to form an empirical database. In this way, correlations between material properties and/or system parameters may be determined. Moreover, the computer system may apply a learning algorithm or AI such that the PLC may automatically control the speed of movement of the slip form based on known material properties and system properties. Furthermore, information indicative of the production rate of the formed building structure may be communicated to the remote computer system, for example, for commercial purposes.

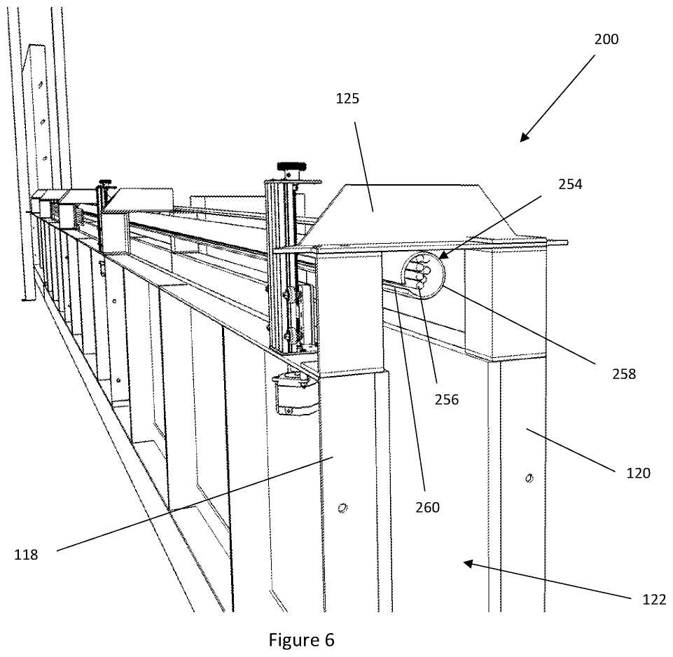

In another example as shown in FIG. 6, there is shown a slip form system 200 comprising a reinforcement dispenser 254 for dispensing a plurality of reinforcement bars 256. Other features of the slip form system 200 are similar to slip form system 100 and like numerals refer to like components. The reinforcement dispenser 254 comprises a longitudinal cylinder 258 for storing the reinforcement bars 256. The cylinder 258 comprises a longitudinal slit 260 that has an approximate length of the reinforcement bars 256. A width of the slit 260 is selected such that an individual reinforcement bar 256 can pass through. Thus, by rotating the cylinder 258 about the longitudinal axis of the cylinder 258, the reinforcement bars 256 can be dispensed at periodic intervals. In this way, substantially horizontal reinforcement bars 256 can automatically be cast in place within the formed building structure 102.

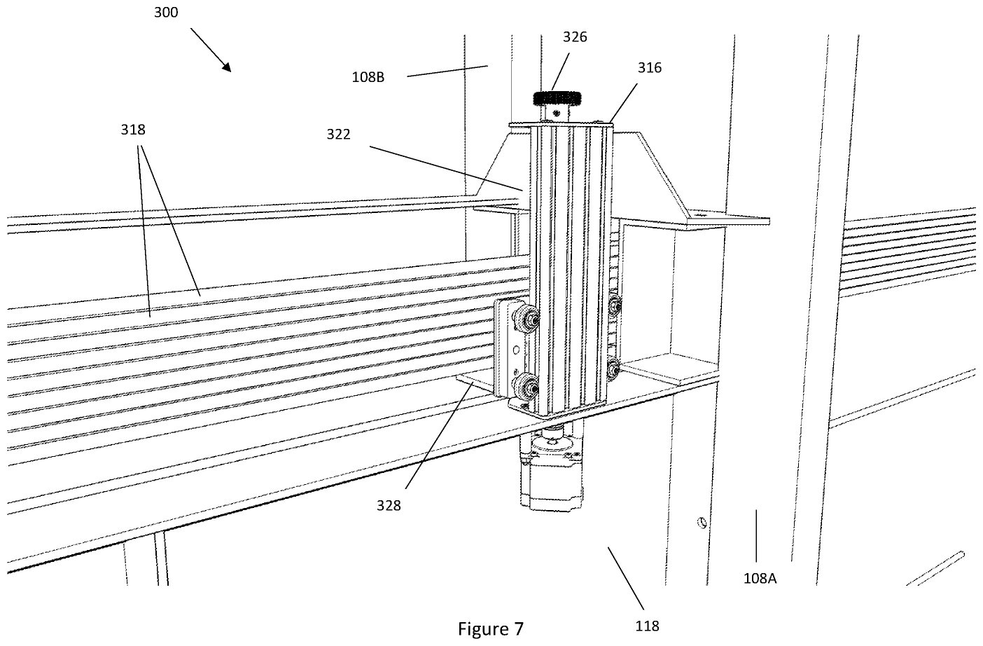

Referring now to FIG. 7, there is shown a schematic representation illustrating an alternative reinforcement dispenser of a slip form system 300 in accordance with a further embodiment of the present invention. It should be noted that like numerals refer to like components. Similar to the reinforcement dispenser 154 of slip form system 100 or the reinforcement dispenser 254 of slip form system 200, the reinforcement dispenser 316 has the function of dispensing a plurality of reinforcement bars 318 into the continuously forming building structure (not shown). The reinforcement dispenser 316 comprises a storage for storing a plurality of reinforcement bars 318, in this example in the form of a plurality of brackets 320 that are attached to a top portion of the slip form 306. Each bracket 320 is formed to define an opening 322 at a top portion of the bracket 320 such that when the plurality of reinforcement bars 318 are lifted, an individual reinforcement bar 318 can be discharged through the opening 322. Once the individual reinforcement bar 318 is guided through the opening 322, the bar 318 drops into the slip form 106 where it is either received by the wet material mixture or in a guided recess at a bottom portion of the slip form 106.

In order to lift the plurality of reinforcement bars 318 within the storage of the reinforcement dispenser 316, the reinforcement dispenser 316 further comprises an actuator 326. The actuator 326 is in the form of a linear actuator 326 that comprises a support plate 328 that can be raised to discharge individual reinforcement bars 318 through the opening 322. A person skilled in the art will appreciate that the actuator 326 may move the support plate 328 continuously, periodically or upon request by the PLC so that a plurality of spaced horizontal reinforcement bars are provided within the formed building structure.

In some embodiments, the slip form system is configured to be attached to an existing apparatus that may or may not be movable. Exemplary apparatus may include but are not limited to an excavator, a forklift, a scissor lift, a scaffolding and the like.

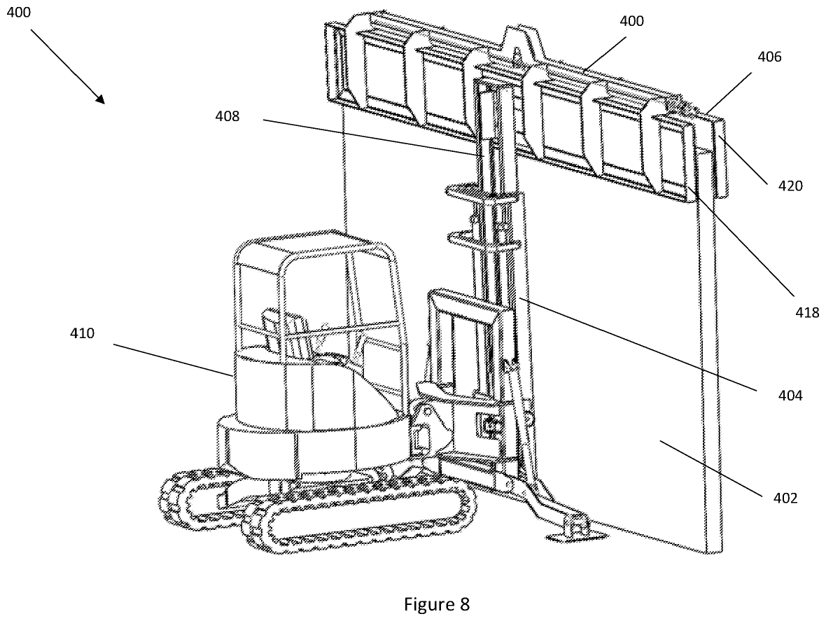

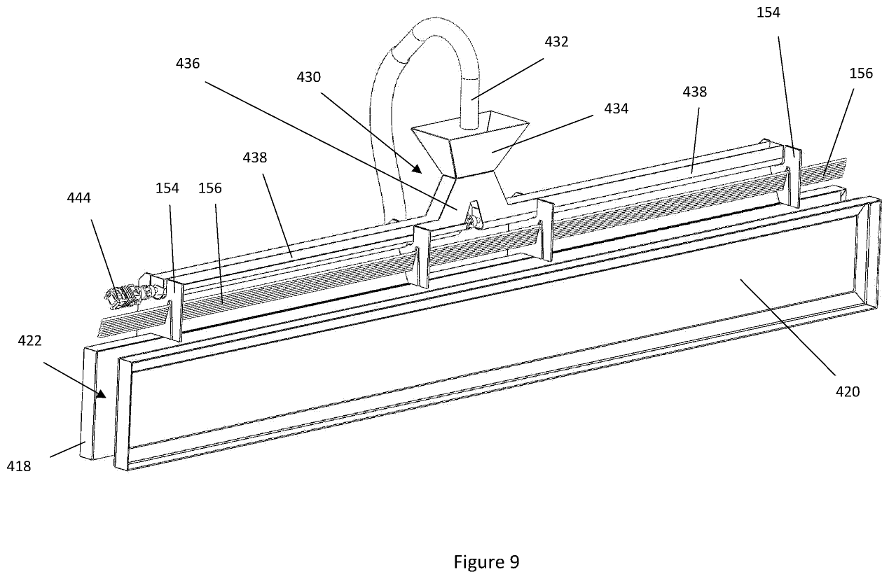

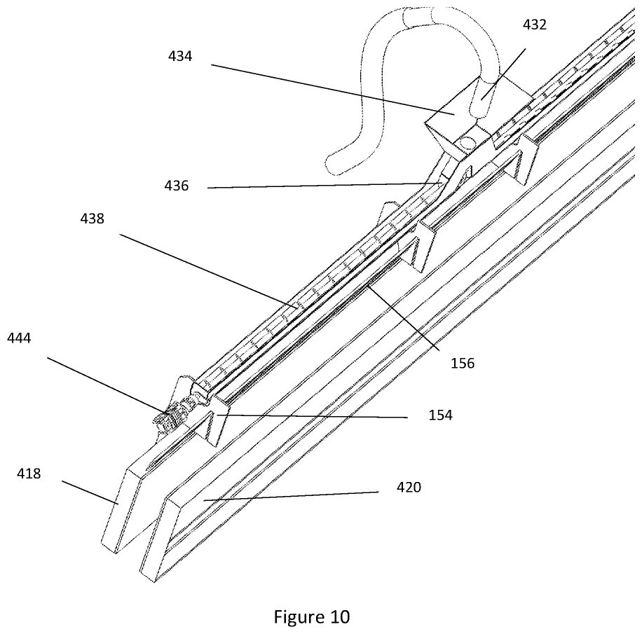

Referring now to FIGS. 8 to 11, there is shown a slip form system 400 in accordance with a further embodiment of the present invention. In this particular embodiment, the slip form system 400 is movable which provides the significant advantage that the slip form system can move to form a further building structure once the present building structure 402 is completed. Similar to slip form system 100 shown in FIGS. 1 to 5, the slip form system 400 is configured to form a straight wall portion 102 made of concrete, as particularly shown in FIG. 8. However, a person skilled in the art will appreciate that other building structures are envisaged.

The slip form system 400 comprises a support 404 for supporting a slip form 406. The support 404 in this example comprises a hydraulically actuated cylinder 408 that is extendable in length whereby the slip form 406 can be lifted. The cylinder 408 is attachable to a front portion of an excavator 410 as shown in particular in FIG. 8. The excavator 410 may be a conventional excavator that is modified to suit the current application. Alternatively, the excavator 410 may be a purpose-built apparatus that may or may not be permanently attached to the support 404 of the slip form system 400. Other suitable apparatus for attaching to the support 404 of the slip form system 400 are envisaged, including but not limited to a forklift or a scissor lift.

In embodiments in which the slip form system 400 is attached to an existing apparatus, movement of the slip form and/or other parameters of the slip form system 400 may be controlled by the apparatus, such as the excavator 410. In this regard, the slip form system 400 may comprise a connector for electronically connecting the slip form system 400 to an actuator and a controller of the existing apparatus.

As for slip form system 100, the slip form system 400 comprises a slip form 406 with first and second longitudinally extending spaced side walls 418, 420 that define a space 422 for receiving a flow of the material mixture from an inlet 224. The side walls 218, 220 of the slip form 206 are connected to each other through connectors 226. In this example, the connectors 226 comprise a hinge (not shown) that facilitates for the slip form 406 to open via the hinge. In this way, once the building structure 402 is completed, at least one of the side walls 418, 420 is moved relates to the other side wall 418, 420 such that the slip form 406 can be removed from the top portion of the building structure 402. In some embodiments, the hinge of the slip form may be actuated by an actuator, such as by the excavator or an additional actuator.

The slip form system 400 also comprises a material discharger 430 for discharging the material mixture into the slip form 406. In this particular example, the material discharger 430 is stationary and extends along the entire length of the slip form 406. The material discharger 430 comprises an inlet 432 for receiving the material mixture and an outlet 433 for discharging the material into the slip form 406. The material discharger 430 further comprises a hopper 434 for receiving the material mixture from the inlet 432 and a mixing chamber 436 for mixing the received material mixture. For example, the material mixing chamber 436 may be configured to continuously mix the material mixture to stop the material mixture from setting. As described above, the mixing chamber may comprise a mixing component, such as a mechanical stirrer, where a sensor for detecting a torque may be provided.

While in this example the inlet 432 is configured to provide the material mixture, a person skilled in the art will appreciate that the material discharger 430 may comprise a plurality of inlets for providing separate components of the material mixture. For example, multiple inlets may be configured to direct a flow of components of the material mixture into the hopper 434 to be sufficiently mixed in the mixing chamber 436.

The material discharger 430 further comprises a material distribution channel 438 and a variable control valve 440. The material distribution channel 438 is configured such that material mixture in the mixing chamber 436 is substantially evenly distributed and discharged through the outlet 433. The variable control valve 440 is configured at the outlet 433 of the material discharger 430 to selectively open and close the outlet 433. A person skilled in the art will appreciate that any suitable variable control valve 440 is envisaged.

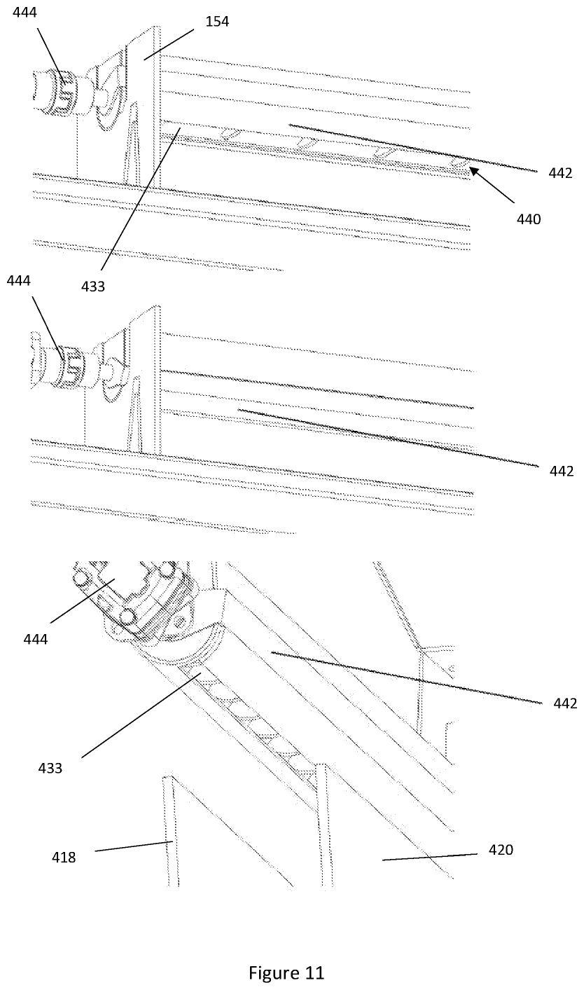

In this embodiment, the variable control valve 440 is controllable to not only open and close the outlet 433, but also to vary the amount of material mixture to be discharged into the slip form 406. Operation of the variable control valve 440 is schematically illustrated in FIG. 11A in which FIGS. 11A, 11B and 11C illustrate different configurations of the variable control vale 440. The material discharger 430 in this example has an overall substantially cylindrical form and the variable control valve 440 comprises a material distribution screw 442 and a screw drive 444 for operating the material distribution screw 442. The material distribution screw 442 extends along the entire cylindrical form of the material discharger 430 and is movable relative to the outlet 433 of the material discharger 430 thereby moving between an open configuration of the outlet 433 as shown in FIG. 11A and a closed configuration of the outlet 433 as shown in FIG. 11B.

Similar to the slip form system 100 shown in FIGS. 1 to 5, the slip form system 400 comprises reinforcement dispenser 154 for dispensing reinforcement bars 156 into the formed building structure. In this regard, like numerals refer to like features.

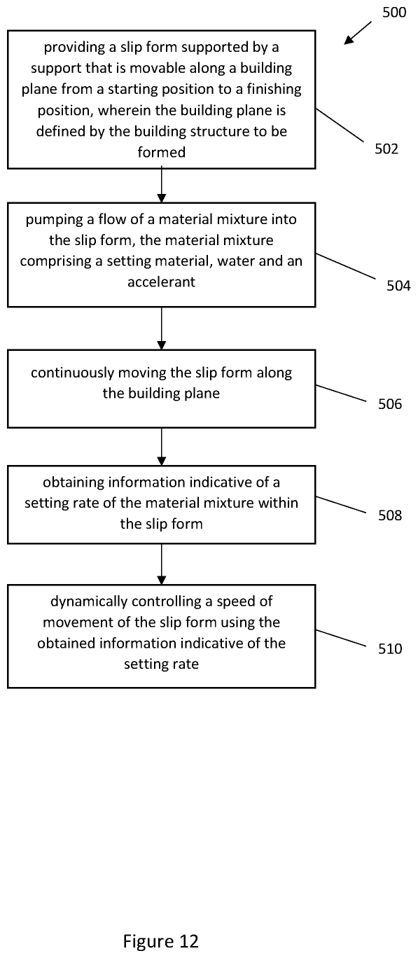

Referring now to FIG. 12 of the accompanying drawings, there is shown a flow chart illustrating a method 500 of forming a building structure, such as wall structure 102, using slip forming. The method 500 comprises an initial step of providing 502 a slip form supported by a support, such as frame 104 or support 404, that is movable along a building plane from a starting position to a finishing position, wherein the building plane is defined by the building structure to be formed. In the example shown in FIGS. 1 to 5, the building plane is a vertical plane. However, a person skilled in the art will appreciate that other building planes are envisaged, including but not limited to a horizontal plane, an angled plane or a curved plane.

The method 500 further comprises a step of pumping 504 a flow of a material mixture into the slip form. The material mixture comprises a setting material and an accelerant and may for example be accelerated concrete. Once the material mixture has reached a pre-determined level within the slip form, the slip form is continuously moved 506 along the building plane.

In this embodiment, the method 500 comprises a step of obtaining 508 information indicative of a setting rate of the material mixture within the slip form. This may, for example, be achieved by detecting a pressure, deflection, yield stress, temperature, resistivity or any other suitable parameters of the material mixture within the slip form. Based on the information indicative of the setting rate of the material mixture, a movement of the slip form is dynamically controlled 510 such that a continuous building structure is formed.

The method 500 has significant advantages in that the process of forming the building structure using slip forming can be optimised. Specifically, a time period of forming the building structure may be minimised whilst reducing the risk of any deformations of the building structure. For example, if the slip form is lifted too quickly, deformations in the form of bulging of the building structure may occur.

Furthermore, in accordance with embodiments of the present invention, a building structure can be provided that is still in a green state. Thus, the building structure has set but has not appreciably hardened. This provides the significant advantage that surface areas of the formed building structure can be treated, such as screeded troweled or sanded to provide for a smooth finished surface.

In some embodiments of the present invention, the method 500 may comprise a step of obtaining information indicative of the following properties associated with the material mixture:
a setting rate of the material mixture;
a viscosity of the material mixture or of one or more components of the material mixture;
a level of material mixture within the slip form; and
a height/angle of the formed building structure;
The method 500 may further comprise a step of using the obtained information to dynamically control one or more of the following system parameters:
the movement of the slip form, such as speed, angle, acceleration;
the flow rate of the material mixture into the slip form; and
the flow rate of one or more components of the material mixture thereby modifying the composition of the material mixture.

It will be appreciated by persons skilled in the art that numerous variations and/or modifications may be made to the invention as shown in the specific embodiments and/or aspects without departing from the spirit or scope of the invention as broadly described. For example, it will be apparent that certain features of the invention can be combined to form further embodiments. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings.

1. A slip form system for forming a building structure, the slip form system comprising:
an inlet for receiving a flow of a material mixture comprising a setting material and an accelerant;
a slip form having first and second longitudinally extending spaced side walls to define a space for receiving a flow of the material mixture from the inlet, the slip form defining cross-sectional dimensions of the formed building structure;
a support supporting the slip form such that the slip form can continuously move along a building plane from a starting position to a finishing position, the building plane being defined by the building structure to be formed;
an actuator for continuously moving the slip form supported by the support; and
a controller in communication with the actuator and configured to dynamically control the moving slip form;
wherein the slip form system is configured such that when a flow of material mixture is received within the slip form, the controller uses information relating to a setting rate of the material mixture to control movement of the slip form to continuously form the building structure.

2. The slip form system of claim 1 comprising a sensor for detecting a material property associated with the material mixture that is indicative of the setting rate of the material mixture.

3. The slip form system of claim 2, comprising a sensor for detecting a pressure of the material mixture against an inner portion of a side wall of the slip form, wherein the controller is in communication with the pressure sensor to use the detected pressure to dynamically control the movement of the slip form.

4. The slip form system of claim 2, comprising a penetrometer sensor for detecting a yield stress of the material mixture in the space defined by the slip form, wherein the controller is in communication with the penetrometer sensor to use the detected yield stress to dynamically control the movement of the slip form.

5. The slip form system of claim 2, comprising a sensor for detecting a resistivity of the material mixture within the slip form, wherein the side walls of the slip form comprise electrical contacts such that a current can be applied through the material mixture.

6. The slip form system of claim 2, comprising a flow sensor for detecting a flow rate of the material mixture into the inlet and/or into the slip form, wherein the controller is in communication with the flow sensor to use the detected flow rate to dynamically control the movement of the slip form.

7. The slip form system of claim 1, wherein the controller is configured to control the flow rate of the material mixture and/or the flow rate of components of the material mixture and/or a dosage rate of admixtures.

8. The slip form system of claim 1, comprising a first inlet for receiving the setting material in the form of a slurry, and a second inlet for receiving the accelerant.

9. The slip form system of claim 7, comprising a torque or current sensor for detecting a respective torque or current of a mixer that is mixing at least the setting material and the accelerant, wherein the controller is in communication with the torque sensor or the current sensor to use the detected torque or current to dynamically control the movement of the slip form and/or the flow rate of the accelerant and/or plasticiser.

10. The slip form system of claim 2, comprising a sensor for detecting a deformation of the formed building structure, wherein the controller is in communication with the deformation sensor to use the detected deformation to dynamically control the movement of the slip form.

11. The slip form system of claim 1, comprising at least one position sensor to detect a position of the slip form, wherein the controller is in communication with the at least one position sensor to dynamically control the movement of the slip form and/or the flow rate of the material mixture into the slip form.

12-14. (canceled)

15. The slip form system of claim 1, being configured to move the slip form from a starting position where the flow of the material mixture is initiated, to a first finishing position where the flow of the material mixture is stopped, to a second finishing position where the slip form can be removed from the finished, formed building structure.

16. (canceled)

17. The slip form system of claim 15, wherein the support comprises a release component for moving the slip form out of the building plane.

18. The slip form system of claim 13, comprising one or more extensions at a top portion of the frame that guide the rope or cable supporting the slip form away from the building plane.

19. The slip form system of claim 1, wherein the side walls of the slip form are connected through a hinge such that at least one of the side walls can pivot relative to the other side wall of the slip form.

20. The slip form system of claim 1, comprising a material discharger for discharging the material mixture into the space of the slip form, wherein the material discharger is in fluid communication with the inlet and is configured to evenly discharge the material mixture along the longitudinal space of the slip form.

21. The slip form system of claim 1, comprising a material discharger for discharging the material mixture into the space of the slip form, wherein the material discharger is in fluid communication with the inlet and in the form of a discharger unit that is moveable along a length of the slip form.

22. The slip form system of claim 1, comprising a reinforcement dispenser for automatically dispensing one or more reinforcement structures into the continuously forming building structure.

23. The slip form system of claim 18, wherein the reinforcement dispenser comprises a storage for storing a plurality of reinforcement bars, the storage comprising an opening, and wherein the reinforcement dispenser comprises an actuator for moving an individual reinforcement bar through the opening.

24.-25. (canceled)

26. A method of forming a building structure using slip forming, the method comprising:
providing a slip form supported by a support that is movable along a building plane from a starting position to a finishing position, the building plane being defined by the building structure to be formed;
pumping a flow of a material mixture into a slip form, the material mixture comprising a setting material and an accelerant;
obtaining information relating to a setting rate of the material mixture;
continuously moving the slip form along the building plane; and
dynamically controlling a movement of the moving slip form using the information relating to the setting rate of the material mixture such that a continuous the building structure is formed.

27.-29. (canceled)
